(19) United States
(12) Patent Application Publication
(10) Pub. No.: US 2010/0310692 A1
(43) Pub. Date: Dec. 9, 2010

(54) PLODDER MACHINE

(76) Inventor: Kuei-Tsai Lai, Taipei City (TW)

Correspondence Address: RABIN & Berdo, PC, 1101 14TH STREET, NW, SUITE 500, WASHINGTON, DC, 20005, US

(21) Appl. No.: 12/479,634

(22) Filed: Jun. 5, 2009

(51) Int. Cl. B29C 47/10

(52) U.S. Cl. 425/112

(57) ABSTRACT

A plodder machine includes a raw material receiving member, a forming member mounted to a bottom of the receiving member to define a receiving space therebetween, a rolling device mounted in the receiving space, and a mounting base supporting the forming member and a power transmission device thereon. The rolling device is driven by the power transmission device to rotate horizontally and thereby press a raw material into a plurality of forming holes circularly arrayed on the forming member to form bar-shaped products. A screening discharging device is connected to the mounting base and located below the forming member to catch and separate the bar-shaped products from recyclable raw material fragments at reduced labor and time costs. Forming sleeves each having a bore of different cross sectional shape and size can be selectively fitted in the forming holes to change the cross-sectional shapes and sizes of the bar-shaped products.

### FIELD OF THE INVENTION

The present invention relates to a plodder machine for forming bar-shaped environment-friendly charcoal products, and more particularly to a plodder machine that provides upgraded bar forming efficiency and bar-shaped products of various cross sectional shapes and sizes, and automatically collects and separates recyclable raw material fragments from the bar-shaped products to save time and labor costs for subsequent removal of raw material fragments from the products.

### BACKGROUND OF THE INVENTION

The environment-friendly charcoal is a substitute for the conventional charcoal, and the main raw materials thereof include agricultural wastes rich in botanical fibers, such as straws, wood dust, corn stalks, etc. To manufacture the environment-friendly charcoal, first grind and evenly mix the raw materials and then heat the mixed raw materials. Finally, the heated raw material mixture is compressed using a plodder machine into a desired shape for consumers to use. Therefore, the plodder machine is one of the prerequisite apparatuses for producing the environment-friendly charcoal.

FIG. 1 illustrates a conventional plodder machine 10 being used in manufacturing the environment-friendly charcoal. As shown, the plodder machine 10 includes a feed hopper 11, a discharge port 12, a power transmission unit 13, and a compressing unit 14 located inside the plodder machine 10.

To operate the conventional plodder machine 10, first turn on the machine, so that the power transmission unit 13 brings the compressing unit 14 to operate. Then, feed the ground and fully mixed raw materials via the feed hopper 11, and the operating compressing unit 14 will push against the fed raw materials, so that the raw materials are compressed and discharged from the discharge port 12 while being formed into specific shape and size.

The conventional plodder machine 10 has the following disadvantages: (1) the one-way compression and one-way discharging structure thereof largely restricts the production rate, and the productivity thereof is low and ranged only from 0.18 tons to 0.24 tons per hour; (2) the discharge port 12 has fixed size and shape that could not be freely replaced or changed; and (3) there is not any platform provided outside the discharge port 12 for receiving the discharged products, and the discharged products tend to become damaged or defective when falling on the ground.

There are other conventional plodder machines being developed to include a discharging chute for receiving the discharged products. However, in the practical manufacturing process, some raw material fragments are frequently discharged via the discharge port along with the compressed products and fall on the discharging chute. These raw material fragments tend to attach to the surfaces of the compressed products and additional labor and time is required to remove the raw material fragments from the products to thereby form unnecessary increase in the manufacturing cost of the environment-friendly charcoal.

### SUMMARY OF THE INVENTION

A primary object of the present invention is to provide an improved plodder machine to enable increased productivity per unit time.

Another object of the present invention is to provide an improved plodder machine to produce bar-shaped products of different cross sectional shapes and sizes using the same machine.

A further object of the present invention is to provide an improved plodder machine capable of automatically collecting and separating raw material fragments from the bar-shaped products to save the time and labor costs for cleaning the products, and to recycle the raw material fragments.

To achieve the above and other objects, the plodder machine according to the present invention includes a hollow raw material receiving member, a forming member externally mounted to a bottom of the receiving member, a rolling device, a mounting base, and a power transmission device. The forming member and the receiving member together define a receiving space therebetween for receiving a raw material fed into the receiving member. The rolling device is arranged in the receiving space to locate at a bottom thereof for pressing the raw material into the forming member, and has a vertical driving shaft connected to a bottom thereof. The mounting base is located below the forming member to fixedly support the forming member thereon. The power transmission device has a horizontal driving shaft meshing with the vertical driving shaft, so that the rolling device is brought by the power transmission device to rotate horizontally. The forming member includes a plurality of axially extended forming holes arranged corresponding to an operating track of the rolling device, so that the raw material is pressed by the rotating rolling device into the forming holes to form bar-shaped products. The mounting base includes a main support body, into which the vertical driving shaft and the horizontal driving shaft are extended to mesh with each other, and a support framework extended from a bottom of the main support body for the power transmission device to mount thereto.

The forming member further includes a heater for preheating the forming holes and accordingly forming the bar-shaped products in the forming holes. In an operable embodiment, the heater is a heating coil wound around an outer periphery of the forming member. In another operable embodiment, the heater includes heating coils provided inside the forming member to surround the forming holes to reduce heat energy loss at outer periphery of the forming member and provide improved heat transfer.

The forming holes are downward tapered conical holes, and each have an upper opening communicating with the receiving space and a lower opening for discharging the bar-shaped products. The forming member further includes a plurality of forming sleeves that can be selectively and separately fitted in the forming holes. The forming sleeves have outer configuration and diameter corresponding to inner configuration and diameter of the forming holes, and each define a through bore, which can be designed to have different cross-sectional shapes and sizes for changing the cross sectional shapes and sizes of the bar-shaped products.

The rolling device includes a rotary base connected to the vertical driving shaft, at least one support arm horizontally extended through the rotary base to turn horizontally along with the rotary base, and two pressure rollers connected to two opposite ends of the support arm to rotate vertically. The forming holes are circularly arranged on the forming member, and the pressure rollers have a rolling track corresponding to the circularly arranged forming holes.

The plodder machine further includes a screening discharging device located below the forming member and above the mounting base for receiving the bar-shaped products discharged from the forming holes, and having a predetermined slope. The screening discharging device is located outside the main support body of the mounting base and connected to a top of the support framework.

The screening discharging device includes a slant collecting chute having a sidewall extended along three sides thereof and a lower open end, and a screen with a plurality of screen holes and removably mounted on the slant collecting chute at a predetermined height of the sidewall. The slant collecting chute is used to catch and collect raw material fragments fallen from the screen holes, and the screen is used to catch and collect the bar-shaped products. In a preferred embodiment, the slant collecting chute includes a baffle connected to the lower open end thereof, so that the sidewall and the baffle together define a collecting space therebetween for accommodating the raw material fragments.

The screening discharging device can be further provided with a vibrator for shaking the screening discharging device, so that the raw material fragments discharged onto the screen along with the bar-shaped products are vibrated to fall from the screen holes to the slant collecting chute.

In the plodder machine of the present invention, the horizontally rotating rolling device can sequentially press the raw material into a large number of circularly arranged forming holes to enabled increased productivity per unit time. And, by changing the forming sleeves, it is able to produce bar-shaped products of different cross-sectional shapes and sizes to meet different demands. Moreover, with the screening discharging device provided with a screen and a vibrator, raw material fragments discharged from the forming holes onto the screen along with the produced bar-shaped products can be shaken to pass through the screen holes and completely fall to the slant collecting chute for recycling. Therefore, the time and labor costs needed for subsequent product cleaning can be reduced, and the usable raw material fragments can be recycled without being wasted.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a conventional plodder machine;

FIG. 2 is a perspective view of a plodder machine according to a preferred embodiment of the present invention;

FIG. 3 is a longitudinal sectional view of the plodder machine of FIG. 2;

FIG. 4 is a fragmentary and enlarged view of FIG. 3;

FIG. 5 is a perspective view of a forming member of the plodder machine of FIG. 2;

FIG. 6 is a sectional view of the forming member of FIG. 5;

FIG. 7 shows differently configured forming sleeves can be fitted in the forming holes on the forming member to change the cross sectional shape and size of the products formed using the plodder machine;

FIG. 8 is a top view of a raw material receiving member of the plodder machine of FIG. 2;

FIG. 9 is a fragmentary perspective view showing the mesh of a vertical driving shaft with a horizontal driving shaft in the plodder machine of the present invention;

FIG. 10 is a fragmentary perspective view showing a screening discharging device for receiving bar-shaped products and raw material fragments; and

FIG. 11 is a longitudinal sectional view of FIG. 10.

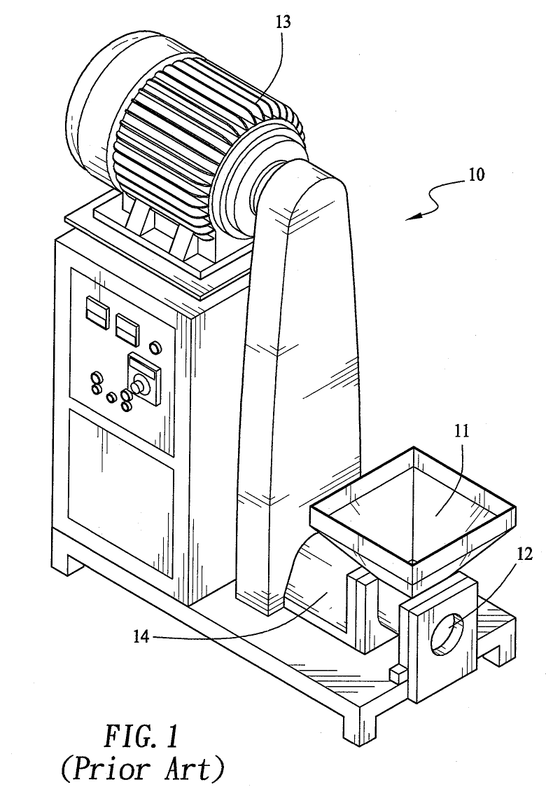

### DETAILED DESCRIPTION OF THE PREFERRED EMBODIMENTS

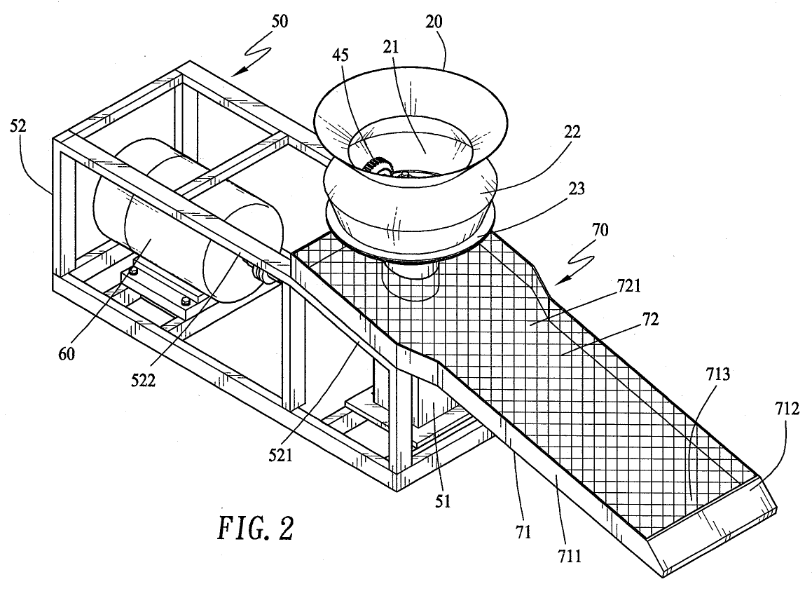

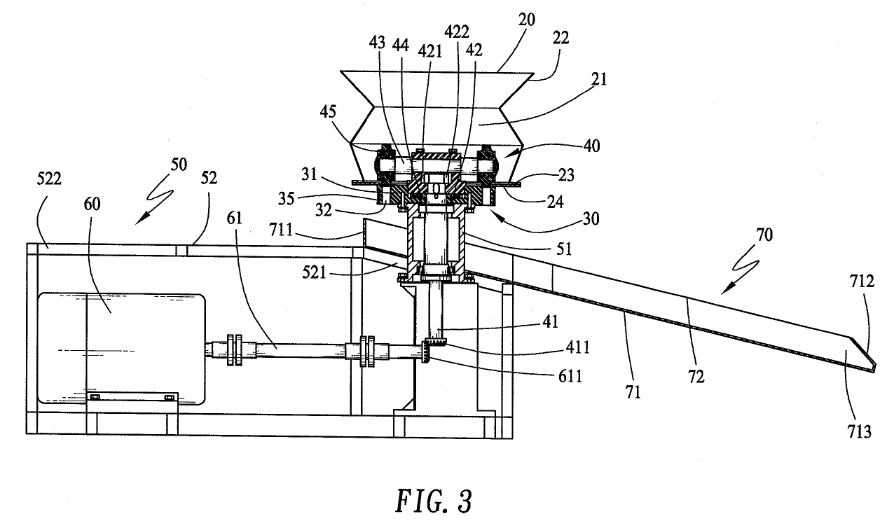

Please refer to FIGS. 2 and 3 that are perspective and longitudinal sectional views, respectively, of a plodder machine according to a preferred embodiment of the present invention. As shown, the plodder machine includes a raw material receiving member 20, a forming member 30, a rolling device 40, a mounting base 50, a power transmission device 60, and a screening discharging device 70. The forming member 30 is externally mounted to a bottom of the raw material receiving member 20 to together define a receiving space 21 for receiving a raw material to be formed into a specific shape. The rolling device 40 is mounted on the forming member 30 to locate in the receiving space 21 at a bottom thereof. A vertical driving shaft 41 is connected to a bottom of the rolling device 40 and meshed with a horizontal driving shaft 61 of the power transmission device 60. The mounting base 50 is connected to a bottom of the forming member 30 via fastening elements. The power transmission device 60 is mounted on the mounting base 50 to drive the rolling device 40 to rotate horizontally via the meshed horizontal and vertical driving shafts 61, 41. The screening discharging device 70 is located below the forming member 30 and is connected to the mounting base 50.

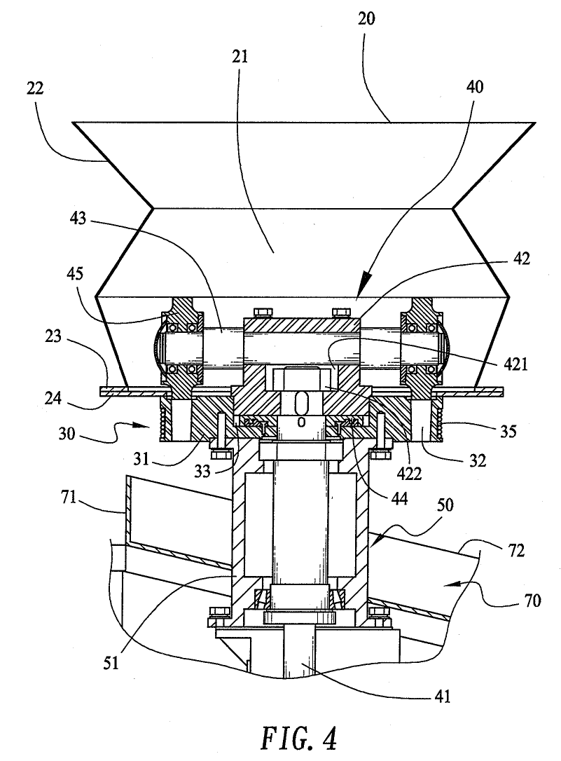

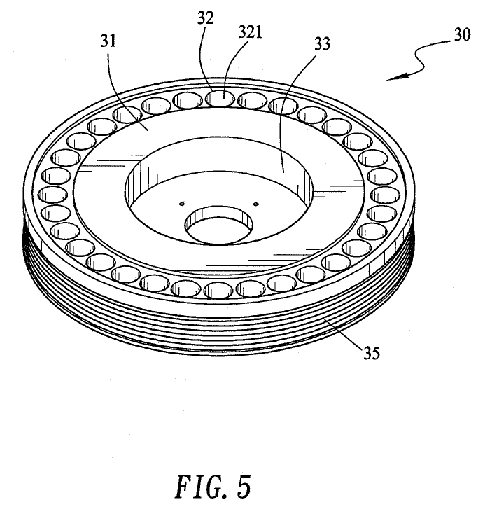

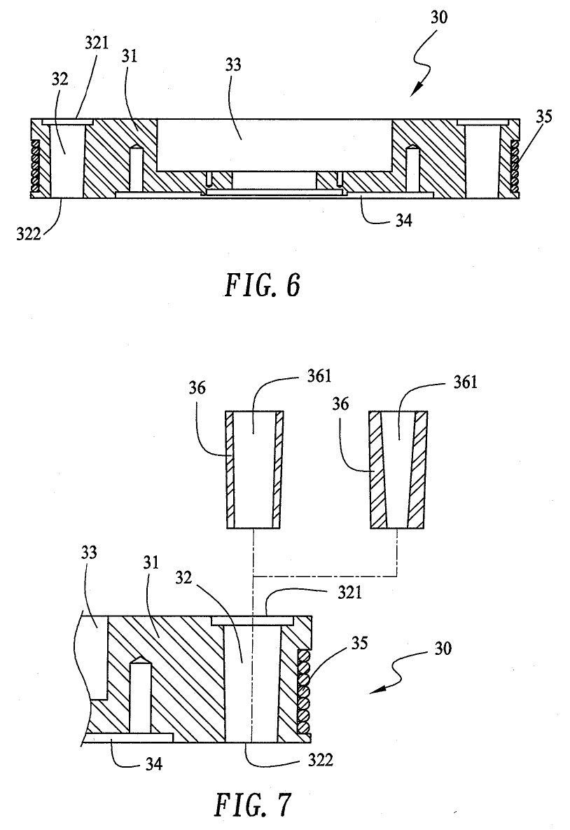

Please refer to FIGS. 4 to 7. In the illustrated preferred embodiment, the raw material receiving member 20 includes a hollow circular wall 22. An annular flange 23 is externally formed around a lower end of the circular wall 22, and a mounting plate 24 is provided to a lower side of the annular flange 23 for the forming member 30 to mount thereto.

The forming member 30 includes a round plate 31. A plurality of axially extended through holes is arrayed along an outer periphery of the round plate 31 to serve as forming holes 32, so that raw material fed into the plodder machine via the receiving member 20 can be pressed into the forming holes 32 to form a plurality of bar-shaped products 80 at one time. A stepped hole 33 is formed at a top center of the round plate 31 for receiving the rolling device 40 therein. Moreover, a stepped recess 34 is formed on a lower side of the round plate 31 for engaging with a top of the mounting base 50. The stepped hole 33 and the stepped recess 34 are internally provided with a plurality of screw holes, via which the rolling device 40 and the mounting base 50 are respectively fixedly connected to the forming member 30 via fastening elements.

The round plate 31 is provided with a heater 35 for heating and accordingly molding the raw material into bar-shaped products 80. In the illustrated preferred embodiment, the heater 35 is a heating coil wound around the outer periphery of the forming member 30. However, in another operable embodiment (not shown), the heater 35 includes heating coils located inside the forming member 30 to wind around the forming holes 32, so as to reduce heat energy loss at the outer periphery of the forming member 30 and provide improved heat transfer.

The forming holes 32 are downward tapered conical holes each having an upper opening 321 communicating with the receiving space 21 and a lower opening 322 for discharging the bar-shaped products 80. Forming sleeves 36 having outer configuration and diameter corresponding to inner configuration and diameter of the forming holes 32 can be selectively and separately fitted in the forming holes 32. Each of the forming sleeves 36 internally defines a through bore 361, which can be differently shaped and sized to change the cross sectional shapes and sizes of the finally formed bar-shaped products 80. In the illustrated preferred embodiment, the through bores 361 have a round cross sectional shape. However, it is understood the through bores 361 are not limited to the round cross sectional shape but can have any other desired cross sectional shapes, such as oblong, square, rectangular, and other geometrical cross sectional shapes.

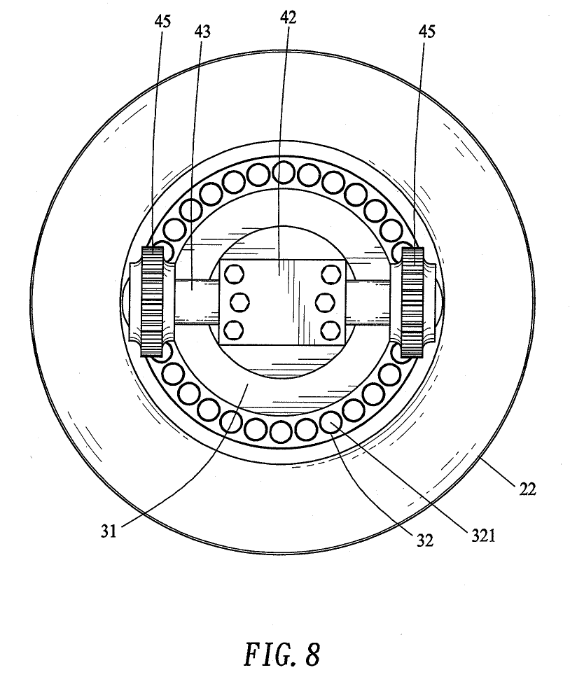

Please refer to FIGS. 4 and 8. The rolling device 40 includes a rotary base 42 connected to the vertical driving shaft 41, and at least one support arm 43 horizontally extended through the rotary base 42. The rotary base 42 is seated in the stepped hole 33 with a pad 44 provided to a bottom thereof to buffer the wearing caused by the rotation of the rotary base 42. The rotary base 42 is internally provided a mounting space 421, into which the vertical driving shaft 41 is extended and secured thereto by an inner nut 422. Two pressure rollers 45 are mounted to two opposite ends of the support arm 43. The pressure rollers 45 are so arranged that their outer circumferential faces are pressed against the upper openings 321 of the forming holes 32. That is, the pressure rollers 45 have a rotating track corresponding to the array of the forming holes 32.

The mounting base 50 includes a main support body 51 connected to the forming member 30 and a support framework 52 extended from a bottom of the main support body 51. The main support body 51 is a hollow structure, through which the vertical driving shaft 41 is extended to connect to the rolling device 40. A through hole (not shown) is formed on the main support body 51 close to a lower end of the vertical driving shaft 41 for the horizontal driving shaft 61 of the power transmission device 60 to extend into the main support body 51 to mesh with the vertical driving shaft 41. A portion of the support framework 52 located immediately below the forming member 30 has a downward inclined top to provide a slant frame 521, and another portion of the support framework 52 opposite to the through hole formed on the main support body 51 is a locating frame 522 for the power transmission device 60 to mount thereto.

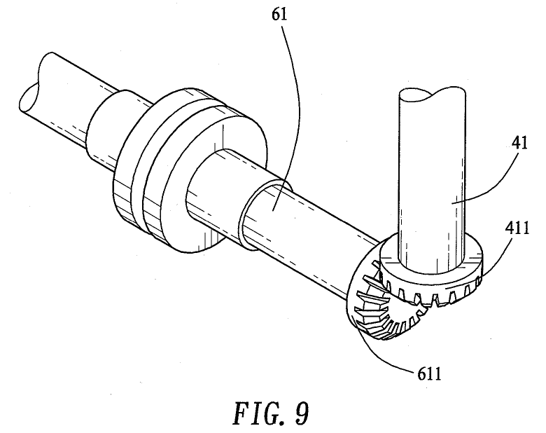

As having been mentioned above, the power transmission device 60 includes a horizontal driving shaft 61 meshing with the vertical driving shaft 41. In the illustrated preferred embodiment, the power transmission device 60 is a motor. Please refer to FIG. 9. The horizontal and the vertical driving shaft 61, 41 are provided at respective free end with a bevel gear 611, 411. And, the horizontal and the vertical driving shaft 61, 41 are connected to each other via mesh of the bevel gear 611 with the bevel gear 411. Through the meshed bevel gears 611, 411, the vertical rotation direction of the horizontal driving shaft 611 can be changed into a horizontal rotation direction of the vertical driving shaft 41.

Please refer to FIGS. 3, 10, and 11 at the same time. The screening discharging device 70 is located outside the main support body 51 and connected to the slant frame 521, so as to have a predetermined slope. The screening discharging device 70 includes a slant collecting chute 71 having a sidewall 711 extended along three sides thereof and a lower open end (not shown). A screen 72 having a plurality of screen holes 721 is removably mounted on the slant collecting chute 71 at a predetermined height of the sidewall 711. The slant collecting chute 71 catches and collects raw material fragments 81 fallen from the screen holes 721. A baffle 712 is connected to the lower open end of the slant collecting chute 71, so that the baffle 712 and the slant collecting chute 71 together define a collecting space 713 between them for accommodating the raw material fragments 81. The screen 72 is spread over the collecting space 713 to catch the bar-shaped products 80 discharged from the lower openings 322 of the forming holes 32.

In an operable embodiment, the screening discharging device 70 can be further provided with an vibrator (not shown) to shake the discharge device 70, so that the raw material fragments 81 discharged onto the screen 72 along with the bar-shaped products 80 can completely fall from the screen holes 721 to the collecting space 713 of the slant collecting chute 71 under shaking.

Please refer to FIG. 7. To use the plodder machine of the present invention, first select forming sleeves 36 having a desired cross sectional shape and size. Then, fit the forming sleeves 36 in the forming holes 32, and turn on a power supply (not shown) to actuate the heater 35 for preheating the forming member 30. Thereafter, turn on the power transmission device 60 to rotate the horizontal driving shaft 61.

Please refer to FIGS. 8 and 9. Through mesh of the bevel gear 611 of the horizontal driving shaft 61 with the bevel gear 411 of the vertical driving shaft 41, the vertical driving shaft 41 is driven to rotate horizontally to thereby further drive the rotary base 42 and the support arm 43 of the rolling device 40 to rotate horizontally. The support arm 43 in rotating will bring the pressure rollers 45 to rotate while pressing against the forming member 30, so that the pressure rollers 45 operate to apply a pressure to the upper openings 321 of the circularly arranged forming holes 32.

Please refer to FIGS. 4 and 8 at the same time. After the above-mentioned procedures, the raw material is fed into the receiving space 21 of the raw material receiving member 20. At this point, the support arm 43 in rotating will bring the pressure rollers 45 to sequentially press the raw material into the forming holes 32. The raw material pressed into the forming holes 32 is heated by the heater 35 to a temperature ranged from 150° C. to 200° C. to form a plurality of bar-shaped products 80, which are discharged via the lower openings 322 of the forming holes 32 onto the screen 72 of the screening discharging device 70.

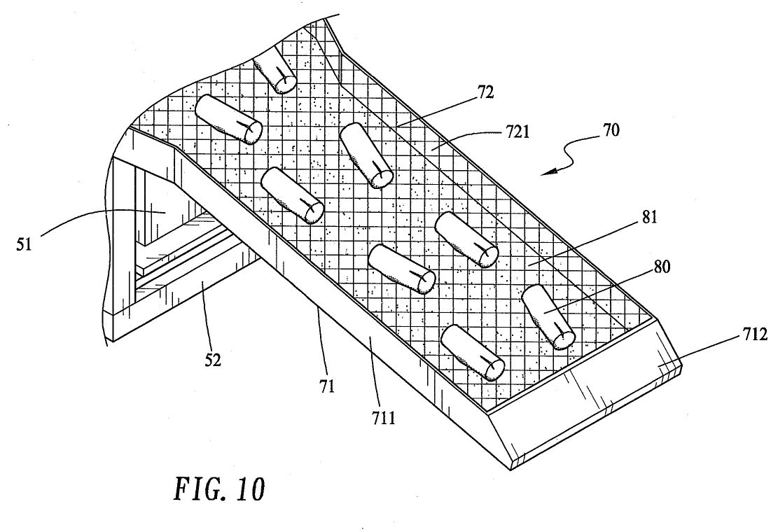

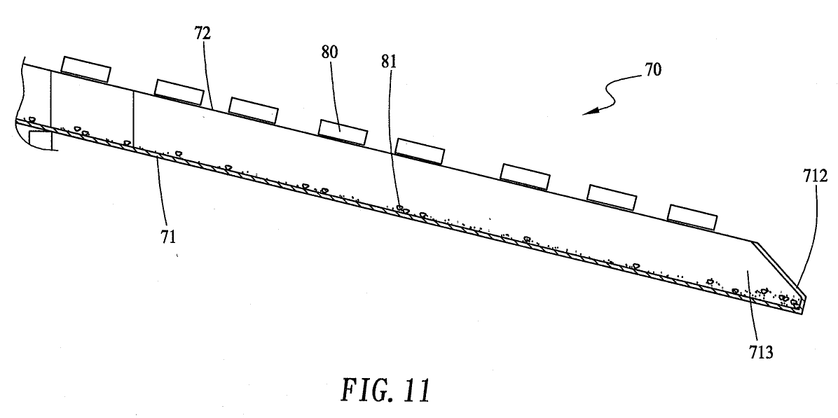

FIGS. 10 and 11 shows the raw material fragments 81 fall from the screen holes 721 onto the slant collecting chute 71 and are collected in the collecting space 713 near the baffle 712. Meanwhile, the screening discharging device 70 is shaken by the vibrator, so that the raw material fragments 81 being discharged along with the bar-shaped products 80 onto the screen 72 can completely fall to the collecting space 713 and separate from the bar-shaped products 80.

To recycle the raw material fragments 81, first remove the screen 72, and then collect the raw material fragments 81 fallen to the collecting space 713 near the baffle 712. The collected raw material fragments 81 can be then fed into the raw material receiving member 20 for producing the bar-shaped products 80. In this manner, a lot of labor, time and material costs for forming the bar-shaped products 80 via the plodder machine can be saved.

With the plodder machine of the present invention, the horizontally rotating rolling device can sequentially press the raw material into a large number of forming holes to enabled increased productivity ranged from 1.8 tons to 2.0 tons per hour. And, by changing the forming sleeves, it is able to produce bar-shaped products of different cross-sectional shapes and sizes. Moreover, with the screening discharging device, raw material fragments discharged along with the produced bar-shaped products from the forming holes onto the screen can be shaken to pass through the screen holes and completely fall to the slant collecting chute for recycling. Therefore, the time and labor costs needed for subsequent cleaning work can be reduced.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A plodder machine, comprising a hollow raw material receiving member, a forming member externally mounted to a bottom of the receiving member, a rolling device, a mounting base, and a power transmission device; the forming member and the raw material receiving member together defining a receiving space therebetween for receiving a raw material fed into the raw material receiving member; the rolling device being mounted in the receiving space to locate at a bottom thereof for pressing the fed raw material into the forming member, and having a vertical driving shaft connected to a bottom thereof; the mounting base being located below the forming member to support the forming member thereon; the power transmission device having a horizontal driving shaft meshing with the vertical driving shaft, so that the rolling device is brought by the power transmission device to rotate horizontally; the forming member including a plurality of axially extended forming holes arrayed corresponding to an operating track of the rolling device, so that the raw material is pressed by the rotating rolling device into the forming holes to form bar-shaped products; and the mounting base including a main support body, into which the vertical driving shaft and the horizontal driving shaft are extended to mesh with each other, and a support framework extended from a bottom of the main support body for the power transmission device to mount thereto.

2. The plodder machine as claimed in claim 1, wherein the forming member further includes a heater for preheating the forming holes and accordingly forming the bar-shaped products in the forming holes.

3. The plodder machine as claimed in claim 2, wherein the heater is a heating coil wound around an outer periphery of the forming member.

4. The plodder machine as claimed in claim 2, wherein the heater includes heating coils provided inside the forming member to surround the forming holes.

5. The plodder machine as claimed in claim 1, wherein the forming holes are downward tapered conical holes, and each have an upper opening communicating with the receiving space and a lower opening for discharging the bar-shaped products.

6. The plodder machine as claimed in claim 1, wherein the forming member further includes a plurality of forming sleeves selectively and separately fitted in the forming holes; the forming sleeves having outer configuration and diameter corresponding to inner configuration and diameter of the forming holes, and each defining a through bore, which can be designed to have different cross-sectional shapes and sizes.

7. The plodder machine as claimed in claim 1, wherein the rolling device includes a rotary base connected to the vertical driving shaft, at least one support arm horizontally extended through the rotary base to turn horizontally along with the rotary base, and two pressure rollers connected to two opposite ends of the support arm to rotate vertically; and wherein the forming holes are circularly arrayed on the forming member, and the pressure rollers have a rolling track corresponding to the circularly arrayed forming holes.

8. The plodder machine as claimed in claim 1, further comprising a screening discharging device located below the forming member and above the mounting base, and having a predetermined slope.

9. The plodder machine as claimed in claim 8, wherein the screening discharging device is located outside the main support body of the mounting base and connected to a top of the support framework.

10. The plodder machine as claimed in claim 9, wherein the screening discharging device includes a slant collecting chute having a sidewall extended along three sides thereof and a lower open end, and a screen having a plurality of screen holes being removably mounted on the collecting chute at a predetermined height of the sidewall; the slant collecting chute being used to catch and collect raw material fragments fallen from the screen holes, and the screen being used to catch and collect the bar-shaped products.

11. The plodder machine as claimed in claim 10, wherein the slant collecting chute includes a baffle connected to the lower open end thereof, so that the slant collecting chute and the baffle together define a collecting space therebetween for accommodating the raw material fragments.

12. The plodder machine as claimed in claim 10, wherein the screening discharging device is further provided with a vibrator for shaking the screening discharging device, so that the raw material fragments discharged onto the screen along with the bar-shaped products fall from the screen holes to the slant collecting chute under shaking by the vibrator.
